(19) United States
(12) Patent Application Publication
(10) Pub. No.: US 2011/0197494 A1
(43) Pub. Date: Aug. 18, 2011

(54) Wade Fishing Caddy

(76) Inventors: Curtis Schumacher, Port O'Connor, TX (US); Cheryl Schumacher, Port O'Connor, TX (US)

(21) Appl. No.: 12/708,363

(22) Filed: Feb. 18, 2010

(51) Int. Cl. A01K 97/06

(52) U.S. Cl. 43/54.1

(57) ABSTRACT

A wade fishing caddy may include a float body, a tackle box compartment adapted to hold a tackle box and formed in the float body, a cooler compartment adapted to hold a cooler and formed in the float body, a stringer compartment adapted to hold a stringer and formed in the float body, a rod holding device adapted to hold a fishing rod and formed in the float body and a drink holding compartment adapted to hold a drinking cup and formed in the float body. The float body may be formed from closed cell Styrofoam, and the float body may be substantially rectangular.

### FIELD OF THE INVENTION

### Background

Wade fishing is a popular recreational pastime. Although wade fishing is enjoyed by many, carrying all of the items necessary for wade fishing out into the water can be difficult. It would be a benefit, therefore, to have a wade fishing caddy that included a float body for supporting a cooler, a tackle box, a number of fishing rod holders, a cup holder, and a number of tether rope attachment devices.

### SUMMARY

A wade fishing caddy may include a float body, a tackle box compartment adapted to hold a tackle box and formed in the float body, a cooler compartment adapted to hold a cooler and formed in the float body, a stringer compartment adapted to hold a stringer and formed in the float body, a rod holding device adapted to hold a fishing rod and formed in the float body and a drink holding compartment adapted to hold a drinking cup and formed in the float body.

The float body may be formed from closed cell Styrofoam, and the float body may be substantially rectangular.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the wade fishing caddy (float body) of the present invention;

FIG. 2 illustrates a bottom view of the wade fishing caddy of the present invention;

FIG. 3 illustrates a portion of the wade fishing caddy including the fishing rod holder and the tether device;

FIG. 4 illustrates a side view of the wade fishing caddy of the present invention;

FIG. 5 illustrates a front view of the wade fishing caddy of the present invention;

FIG. 6 illustrates the wade fishing caddy in use.

### DETAILED DESCRIPTION

It is thus an object of the invention to provide a wade fishing caddy that may include a rectangular, closed cell foam float body, a tackle box compartment, a cooler compartment, a drink holder compartment, a rod holding device and a drink holding compartment. The float body may be oval-shaped, circular shaped or other appropriate shapes and maybe formed from other materials such as wood, plastic or other suitable materials. The substantially rectangular, closed cell foam float body may include a cooler compartment formed into the float body and accessible through a cooler opening formed through the top float body surface, a tackle box compartment formed into the float body and accessible through a tackle box opening formed through top float body surface, and two spaced cylinder shaped fishing rod handle insertion cavities formed through the top float body surface, a cylinder shaped strainer storage cavity formed into the float body and accessible through a strainer opening formed in the top float body surface and a cylinder shaped drink holder cavity formed into the float body and accessible through a drink holder opening formed in the top float body surface. The float body may additionally include a tethering device which may be an eye bolt which may extend into the top surface of the float body and can be used to tether the float body to the user, to a live bait bucket and to a netting device.

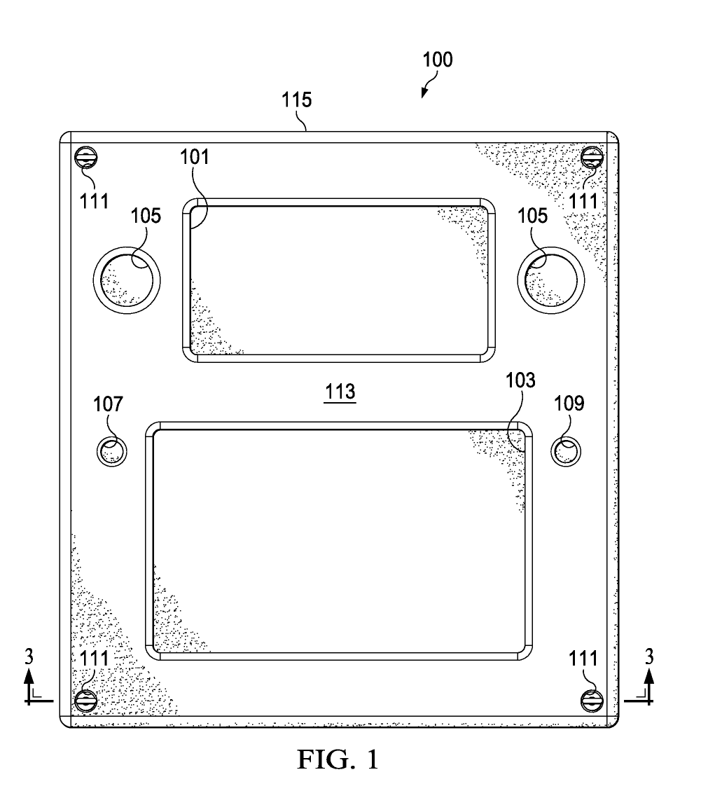

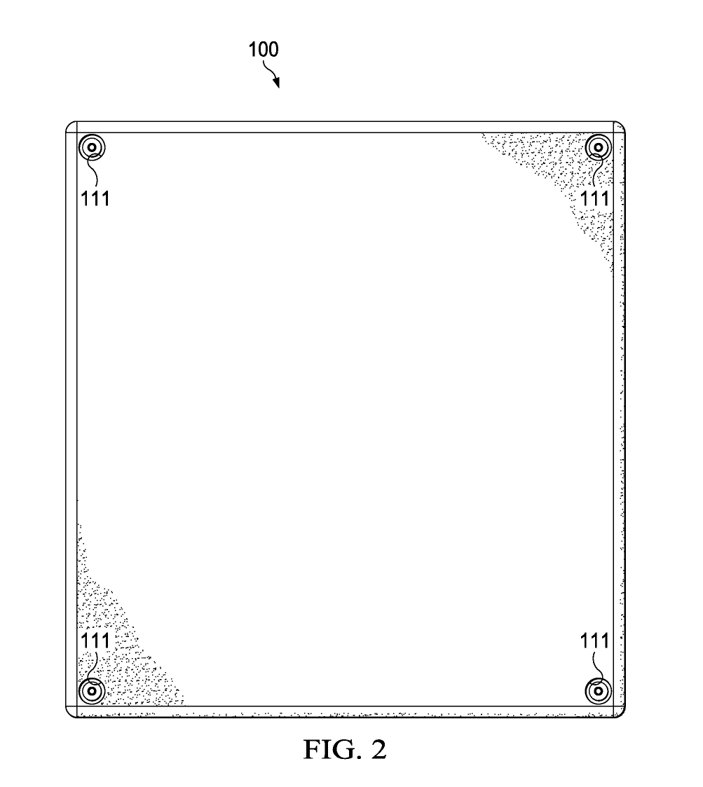

FIG. 1 illustrates a top view of the wade fishing caddy 100 that may include a rectangular, closed cell foam float body, a tackle box compartment 101, a cooler compartment 103, a drink holder compartment, a rod holding device cavity, a stringer storage compartment 109 and a drink holding compartment 107. The float body 100 may include corner apertures 111 which may extend from the top surface 113 to the bottom surface 115 in order to attach eyelets and the corner apertures 111 may be counter sunk from the bottom surface 115 in order to provide a smooth surface. The substantially rectangular, closed cell foam float body 100 may include a cooler compartment 103 formed into the float body 100 and accessible through a cooler opening formed through the top float body surface 113, a tackle box compartment 101 formed into the float body 100 and accessible through a tackle box opening formed through top float body surface 113, and two spaced cylinder shaped fishing rod handle insertion cavities 105 formed through the top float body surface 113, a cylinder shaped strainer storage compartment 107 formed into the float body 100 and accessible through a strainer opening formed in the top float body surface 113 and a cylinder shaped drink holder cavity 107 formed into the float body 100 and accessible through a drink holder opening formed in the top float body surface 113. The float body 100 may additionally include a tethering device 119 which may be an eye bolt 121, washers 123 and a bolt 125 which may extend into the top surface 113 of the float body 100 and can be used to tether the float body 100 to the user, to a live bait bucket and to a netting device.

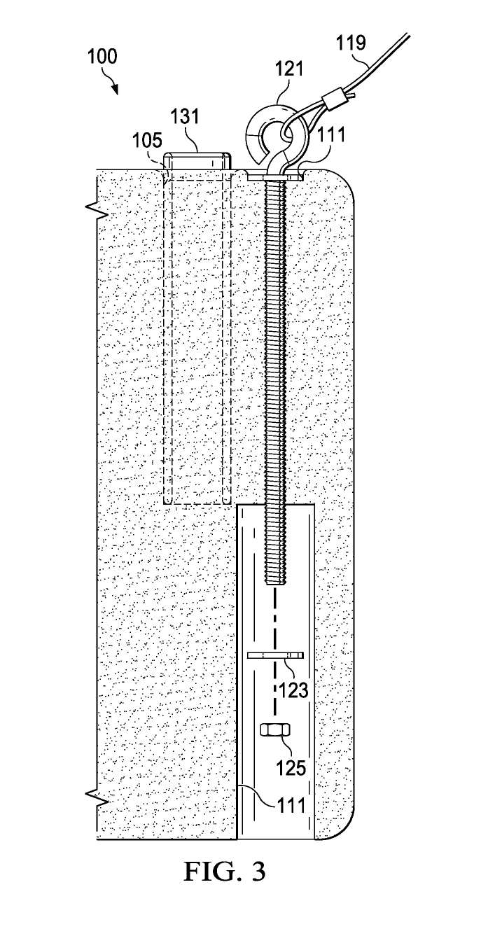

FIG. 3 illustrates the rod holding device 131 which may be a cylinder positioned within the rod holding device cavity 105 and illustrates the tether device 119.

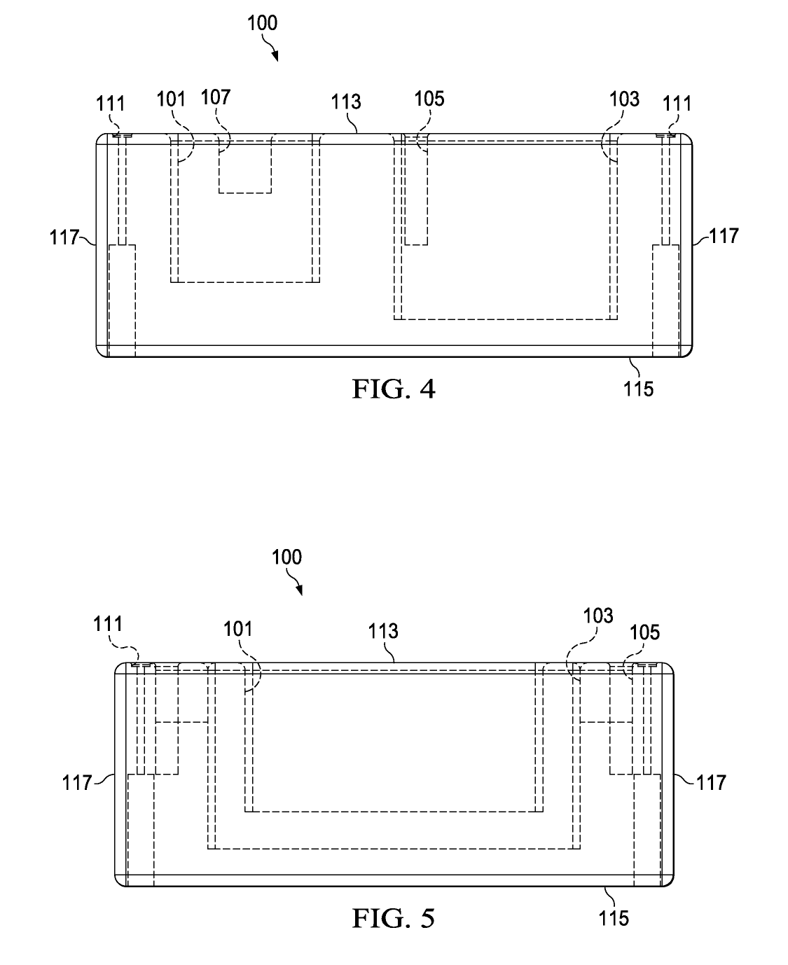

FIG. 4 illustrates a side view of the float body 100 and illustrates the tackle box compartment 101, the cooler compartment 103, the rod holder compartment 105, the drink holder cavity 107, the stringer storage cavity 109 and the corner aperture 111. The top surface 113 is connected to the side surface 117 which may be connected to the bottom surface 115.

FIG. 5 illustrates a front view of the float body 100 and illustrates the tackle box compartment 101, the cooler compartment 103, the rod holder compartment 105, the drink holder cavity 107, the stringer storage cavity 109 and the corner aperture 111. The top surface 113 is connected to the side surface 117 which may be connected to the bottom surface 115.

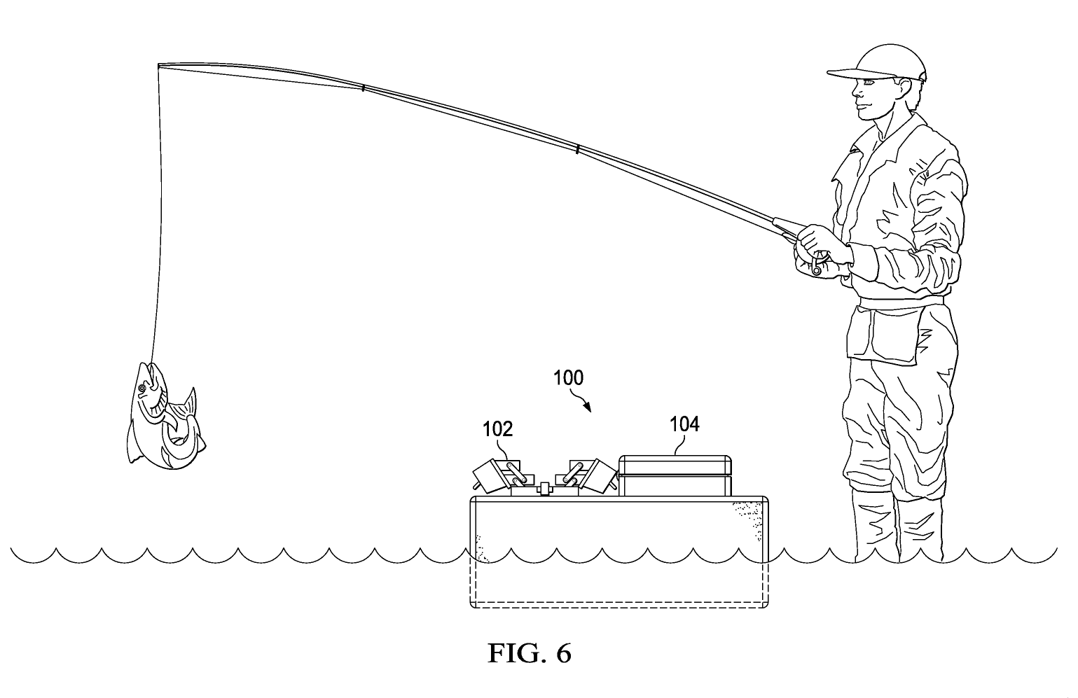

FIG. 6 illustrates the float body 100 which may be floating on the surface of the water and may be tethered to the user and illustrates the tackle box 102 positioned in the tackle box compartment 101 and the cooler 104 positioned within the cooler compartment 103.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A wade fishing caddy comprising:
a float body;
a tackle box compartment adapted to hold a tackle box and formed in the float body;
a cooler compartment adapted to hold a cooler and formed in the float body;
a stringer compartment adapted to hold a stringer and formed in the float body;
a rod holding device adapted to hold a fishing rod and formed in the float body;
a drink holding compartment adapted to hold a drinking cup and formed in the float body.

2) A wade fishing caddy as in claim 1, wherein the float body is formed from closed cell Styrofoam.

3) A wade fishing caddy as in claim 1, wherein the float body is substantially rectangular.

4) A wade fishing caddy as in claim 1, wherein the float body is substantially rectangular.
